(19) United States
(12) Patent Application Publication
(10) Pub. No.: US 2012/0086358 A1
(43) Pub. Date: Apr. 12, 2012

(54) CURRENT CONTROL CIRCUIT FOR LIGHT EMITTING DIODES

(75) Inventor: CHUANG-WEI TSENG, Tu-Cheng (TW)

(73) Assignee: HON HAI PRECISION INDUSTRY CO., LTD., Tu-Cheng (TW)

(21) Appl. No.: 12/965,903

(22) Filed: Dec. 12, 2010

(30) Foreign Application Priority Data
Oct. 6, 2010 (TW) 99133939

(51) Int. Cl. H05B 37/02

(52) U.S. Cl. 315/294

(57) ABSTRACT

A current control circuit for light emitting diodes includes a power source, a current converting unit, a switch control unit and a number of transformers. The current control circuit provides direct current. The current converting unit is electrically connected to the power source and includes two couples of field effect transistors. The switch control unit is electrically connected to the current converting unit and is capable of providing a number of pulse signals to control the current converting unit. The two couples of field effect transistors receive pulse signals from the switch control unit and are alternately switched on and off. The direct current from the power source is converted into corresponding alternating current for the transformers. The current control circuit can provide stable and consistent current, enabling light sources to keep uniform brightness.

### BACKGROUND

1. Technical Field

The disclosure generally relates to control circuits, and more particularly relates to, a current control circuit for light emitting diodes (LEDs).

2. Description of the Related Art

Light emitting diodes (LEDs) are widely used in different electronic devices, such as liquid crystal display (LCD) TV. The LEDs are electrically connected in series and/or in parallel, and the current of each LED is typically controlled by current control circuits including integrated circuits (ICs) and field effect transistors (FETs).

However, such current control circuits traditionally need more FETs and ICs, which may increase design costs. Moreover, after long time use, the resistance of the LEDs increase, so that the forward voltages of the LEDs in series are accumulated, thereby enabling the temperatures of the FETs to rise up. In addition, the brightness of the LEDs may be different and inconsistent due to the different currents flowing through the LEDs.

Therefore, there is room for improvement within the art.

### BRIEF DESCRIPTION OF THE DRAWINGS

Many aspects of an exemplary current control circuit for light emitting diodes can be better understood with reference to the following drawings. The components in the drawings are not necessarily drawn to scale, the emphasis instead being placed upon clearly illustrating the principles of the exemplary current control circuit for light emitting diodes. Moreover, in the drawings, like reference numerals designate corresponding parts throughout the several views. Wherever possible, the same reference numbers are used throughout the drawings to refer to the same or like elements of an embodiment.

FIG. 1 is a circuit view of a current control circuit used for a light emitting diode (LED) group, according to a first exemplary embodiment.

FIG. 2 is a circuit view of a current control circuit used for a LED group, according to a second exemplary embodiment.

### DETAILED DESCRIPTION

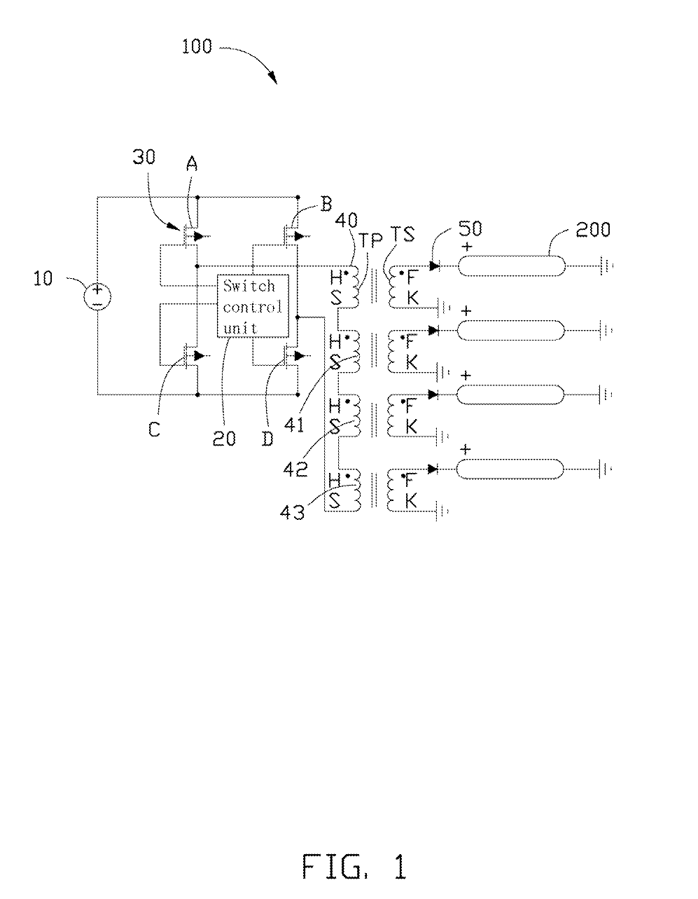

FIG. 1 shows a current control circuit 100 used for providing stable currents for a light emitting diode (LED) group 200 according to a first exemplary embodiment. The LED group 200 includes a plurality of LEDs (not shown) which are electrically connected in parallel and/or in series. The current control circuit 100 includes a power source 10, a switch control unit 20, a current converting unit 30, four transformers 40, 41, 42 and 43, and a plurality of diodes 50. The diodes 50 can be rectifying diodes.

The power source 10 may be a direct current (DC) source, which outputs and provides high voltage DC for the current converting unit 30.

The switch control unit 20 is electrically connected to and the current converting unit 30. The switch control unit 20 generates and provides a number of pulse signals to control the current converting unit 30. Each pulse signal includes a positive pulse and a reverse pulse. The pulse signals have substantially 180-degree phase shift and have the same amplitude and frequency.

The current converting unit 30 electrically connected to the power source 10 can be an inverter circuit and converts the DC into alternating current (AC). The current converting unit 30 includes a first field effect transistor (FET) A, a second FET B, a third FET C, and a fourth FET D, which have the same types. The gates of the first FET A, the second FET B, the third FET C and the fourth FET D are electrically connected to the switch control unit 20 to receive the pulse signals including positive pulses and reverse pulses. The drains of the first FET A and the second FET B are electrically connected to the anode of the power source 10, and the sources of the first FET A and the second FET B are electrically and respectively connected to the drains of the third FET C and the fourth FET D. The sources of the third FET C and the fourth FET D are electrically connected to the cathode of the power source 10.

The first FET A, the second FET B, the third FET C and the fourth FET D form a full-bridge inverter circuit to convert the DC from the power source 10 into AC. Each transformer 40, 41, 42 or 43 includes a primary coil TP and a secondary coil TS. In this exemplary embodiment, for example, when the first FET A and the fourth FET D receive the positive pulses, the first FET A and the fourth FET D are powered on, the second FET B and the third FET C are powered off. Thus, the power source 10, the first FET A, the primary coils TP and the fourth FET D form a first closed-loop circuit. When the first FET A and the fourth FET D receive the reverse pulses from the switch control unit 20, the first FET A and the fourth FET D are powered off, the second FET B and the third FET C are powered on. Thus, the power source 10, the second FET B, the primary coils TP and the third FET C form a second closed-loop circuit, which has opposite current direction with the first closed-loop circuit. Thus, the DC from the power source 10 is converted into AC in the primary coils TP by the current converting unit 30.

The transformers 40, 41, 42 and 43 have the same turn ratio (such as 2:1, 3:1, 2:3) to boost or lower the voltage to enable the LED group 200 to work normally. In this exemplary embodiment, the primary coil TP of each transformer includes a primary like terminal H and a primary unlike terminal S. The primary like terminal H of the primary coil TP in the transformer 40 is electrically between the source of the first FET A and the drain of the third FET C. The primary unlike terminal S of the primary coil TP is electrically connected to the primary like terminal H of the consecutive primary coil TP in series. Until the primary unlike terminal S of the primary coil TP of the transformer 43 is electrically connected between the source of the second FET B and the drain of the fourth FET D.

The secondary coils TS of the transformers 40, 41, 42 and 43 are respectively and electrically connected to a corresponding LED group 200 to power the LED groups 200. The secondary coil TS of each transformer includes a secondary like terminal F and a secondary unlike terminal K, and the secondary like terminals F respectively correspond to the primary like terminals H, the secondary unlike terminals K respectively correspond to the primary unlike terminals S. Thus, the secondary coils TS have the same polarities as the primary coils TP. The four secondary unlike terminals K are electrically connected to ground, and the secondary unlike terminal K of each secondary coil TS is electrically connected to the anode of the corresponding diode 50, and the cathode of the diode 50 is electrically connected to the anode of the LED group 200. Each cathode of the LED groups 200 is electrically connected to ground. Thus, the rectifying diodes 50 convert the AC from the secondary coils TS into DC to power the LED groups 200.

In use, the switch control unit 20 provides positive pulses and reverse pulses for the current converting unit 30. When the first FET A and the fourth FET D are switched on, the second FET B and the third FET C are correspondingly switched off. Therefore, the primary coils TP generate a forward current. When the first FET A and the fourth FET D are alternately switched off, the second FET B and the third FET C are correspondingly switched on alternately, therefore the primary coils TP generates a reverse current. Thus, the forward currents and the reverse currents are alternated in the primary coils TP, so that the DC from the power source 10 is converted into high-frequency AC in the series-connected primary coils TP. Since the turn ratios of the transformers 40, 41, 42, and 43 are same as each other, each secondary coil TS has the same transformed AC flowing through the corresponding LED groups 200. Thus, the LED groups 200 substantially have the same brightness.

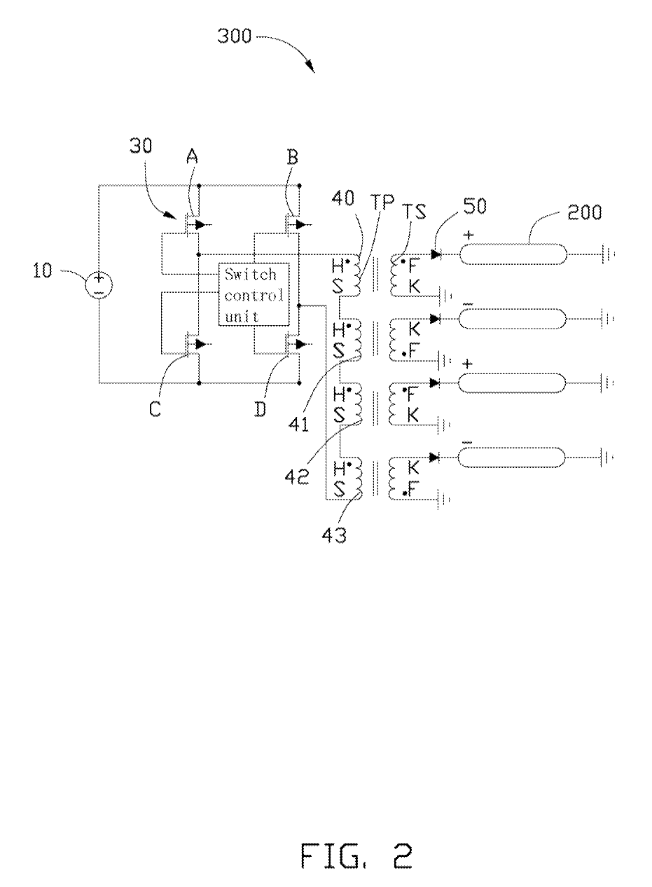

FIG. 2 shows a current control circuit 300 used for providing stable currents for the LED group 200 according to a second exemplary embodiment, which is substantially same as the current control circuit 100 of the first exemplary embodiment. The difference is: the secondary unlike terminals K and the secondary like terminals F of the secondary coils TS in the transformers 41 and 43 are exchanged. Thus, the secondary like terminals F of the transformers 41 and 43 are electrically connected to ground, the secondary unlike terminals K of the transformers 41 and 43 are electrically connected to the cathode of the LED groups 200.

The number of the transformers is not limited to four, and can also be increased and decreased based on the number of the LED groups 200, accordingly, such as three, five, six, eight.

Moreover, because the LEDs in the LED groups 200 themselves have the same rectifying function as the rectifying diodes 50, the rectifying diodes 50 can be omitted. In addition, the LED groups 200 can be other light sources controlled by the current control circuit, such as liquid crystal display (LCD) backlight lamps.

In summary, the primary coils TP of the transformers are electrically connected in series, and the turn ratios of the transformers are equal to each other, so that the AC in the secondary coils TS of the transformers are stable and consistent, enabling the LED groups 200 to keep the substantially same brightness. Moreover, the FETs cannot be easily damaged due to the electrical isolation between the FETs and the LED groups 200. The four FETs are used and are switched on/off under the control of the switch control unit 20 to enable a plurality of transformers and LED groups 200 to work normally, which can reduce the design costs.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A current control circuit for light emitting diodes, comprising:
a power source for providing direct current;
a current converting unit electrically connected to the power source, the current converting unit comprising two couples of field effect transistors;
a switch control unit electrically connected to the current converting unit, the switch control unit providing a plurality of pulse signals to control the current converting unit; and
a plurality of transformers electrically connected to the current converting unit, wherein the two couples of field effect transistors receive the pulse signals from the switch control unit and are alternately switched on and off, and the direct current from the power source is converted into corresponding alternating current for the transformers.

2. The current control circuit for light emitting diodes as claimed in claim 1, wherein one couple of field effect transistors comprises a first field effect transistor and a fourth field effect transistor, the other couple of field effect transistors comprises a second field effect transistor and a third field effect transistor, the gates of the four field effect transistors are electrically connected to the switch control unit to receive the pulse signals.

3. The current control circuit for light emitting diodes as claimed in claim 2, wherein the drains of the first field effect transistor and the second field effect transistor are electrically connected to the anode of the power source, the sources of the first field effect transistor and the second field effect transistor are electrically and respectively connected to the drains of the third field effect transistor and the fourth field effect transistor, and the sources of the third field effect transistor and the fourth field effect transistor are electrically connected to the cathode of the power source.

4. The current control circuit for light emitting diodes as claimed in claim 2, wherein when the first field effect transistor and the fourth field effect transistor are switched on, the second field effect transistor and the third field effect transistor are switched off, and when the first field effect transistor and the fourth field effect transistor are switched off, the second field effect transistor and the third field effect transistor are powered on.

5. The current control circuit for light emitting diodes as claimed in claim 2, wherein each transformer comprises a primary coil and a secondary coil, the primary coils are electrically connected in series, and each secondary coil is electrically connected to a corresponding light source.

6. The current control circuit for light emitting diodes as claimed in claim 5, wherein the transformers have the same turn ratios to boost or lower the voltage to enable light source to work.

7. The current control circuit for light emitting diodes as claimed in claim 5, wherein each primary coil comprises a primary like terminal and a primary unlike terminal, and the primary like terminal of the first primary coil is electrically between the source of the first field effect transistor and the drain of the third field effect transistor, the primary unlike terminal of the primary coil is electrically connected to the primary like terminal of the consecutive primary coil in series, and the last primary unlike terminal is electrically connected between the source of the second field effect transistor and the drain of the third field effect transistor.

8. The current control circuit for light emitting diodes as claimed in claim 7, wherein each secondary coil comprises a secondary like terminal and a secondary unlike terminal, the secondary unlike terminals are electrically connected to ground, and the secondary like terminals respectively correspond to the primary like terminals, the secondary unlike terminals respectively correspond to the primary unlike terminals.

9. The current control circuit for light emitting diodes as claimed in claim 7, wherein each secondary coil comprises a secondary like terminal and a secondary unlike terminal, one part of the secondary like terminals respectively correspond to the primary like terminals, the corresponding secondary like terminals are electrically connected to ground.

10. The current control circuit for light emitting diodes as claimed in claim 5, further comprising a plurality of rectifying diodes electrically connected between the secondary coils and the light sources, wherein the rectifying diodes are capable of converting the alternating current from the secondary coils into direct current.

11. A current control circuit for light emitting diodes, comprising:
a current converting unit for receiving a direct current, the current converting unit comprising two couples of field effect transistors to converting the direct current into alternating current;
a switch control unit electrically connected to the current converting unit, the switch control unit providing a plurality of pulse signals to control the two couples of field effect transistors; and
a plurality of transformers electrically connected to the current converting unit, each transformer comprising a primary coil and a secondary coil, wherein the primary coils are electrically connected in series, each secondary coil is electrically connected to a light source, and the two couples of field effect transistors are alternately switched on and off controlled by the pulse signals from the switch control unit to form corresponding alternating current in the primary coils, the alternating current is transformed by the secondary coil to power the light sources.

12. The current control circuit for light emitting diodes as claimed in claim 11, wherein one couple of field effect transistors comprises a first field effect transistor and a fourth field effect transistor, the other couple of field effect transistors comprises a second field effect transistor and a third field effect transistor, the gates of the four field effect transistors are electrically connected to the switch control unit to receive the pulse signals.

13. The current control circuit for light emitting diodes as claimed in claim 12, wherein the drains of the first field effect transistor and the second field effect transistor are electrically connected to the anode of the power source, the sources of the first field effect transistor and the second field effect transistor are electrically and respectively connected to the drains of the third field effect transistor and the fourth field effect transistor, and the sources of the third field effect transistor and the fourth field effect transistor are electrically connected to the cathode of the power source.

14. The current control circuit for light emitting diodes as claimed in claim 12, wherein when the first field effect transistor and the fourth field effect transistor are switched on, the second field effect transistor and the third field effect transistor are switched off, and when the first field effect transistor and the fourth field effect transistor are switched off, the second field effect transistor and the third field effect transistor are powered on.

15. The current control circuit for light emitting diodes as claimed in claim 11, wherein the transformers have the same turn ratios to boost or lower the voltage to enable light source to work.

16. The current control circuit for light emitting diodes as claimed in claim 12, wherein each primary coil comprises a primary like terminal and a primary unlike terminal, and the primary like terminal of the first primary coil is electrically between the source of the first field effect transistor and the drain of the third field effect transistor, the primary unlike terminal of the primary coil is electrically connected to the primary like terminal of the consecutive primary coil in series, and the last primary unlike terminal is electrically connected between the source of the second field effect transistor and the drain of the third field effect transistor.

17. The current control circuit for light emitting diodes as claimed in claim 16, wherein each secondary coil comprises a secondary like terminal and a secondary unlike terminal, the secondary unlike terminals are electrically connected to ground, and the secondary like terminals respectively correspond to the primary like terminals, the secondary unlike terminals respectively correspond to the primary unlike terminals.

18. The current control circuit for light emitting diodes as claimed in claim 16, wherein each secondary coil comprises a secondary like terminal and a secondary unlike terminal, one part of the secondary like terminals respectively correspond to the primary like terminals, the corresponding secondary like terminals are electrically connected to ground.

19. The current control circuit for light emitting diodes as claimed in claim 11, further comprising a plurality of rectifying diodes electrically connected between the secondary coils and the light sources, wherein the rectifying diodes are capable of converting the alternating current from the secondary coils into direct current.
